(19) United States
(12) Patent Application Publication
(10) Pub. No.: US 2017/0374287 A1
(43) Pub. Date: Dec. 28, 2017

(54) System for Visually Depicting Fields of View of a Commercial Vehicle

(71) Applicant: Werner LANG, Ergersheim (DE)

(72) Inventor: Werner LANG, Ergersheim (DE)

(21) Appl. No.: 15/191,273

(22) Filed: Jun. 23, 2016

(51) Int. Cl. H04N 5/232; G06K 9/00; B60R 1/00

(52) U.S. Cl. CPC H04N 5/23293; B60R 1/00; G06K 9/00791; B60R 2300/105; B60R 2300/202; B60R 2300/8026; B60R 2300/40

(57) ABSTRACT

System for visually depicting fields of view for a commercial vehicle within a driver's cab of the commercial vehicle, the system having at least one display device disposed within the driver's cab and having at least one display unit being configured to display at least one field of view, wherein the at least one display device is configured to be arranged within the driver's cab of the commercial vehicle such that the longitudinal axis thereof is substantially horizontally aligned.

### BACKGROUND OF THE INVENTION

### 1. Field of the Invention

The present invention relates to a system for visually depicting fields of view of a commercial vehicle within a driver's cab of the commercial vehicle.

### 2. Description of the Related Art

In motor vehicles, “fields of view” are for example legally-prescribed (required by law) or in any other way individually defined in accordance with the type of the motor vehicle, such as e.g. motor cycles, motor vehicles for transporting passengers, motor vehicles for transporting goods, etc. The fields of view must be provided by one or more “device for indirect viewing”, which is conventionally a mirror, and the fields of view must be visible or viewable by a driver sitting in the driver's seat using the device(s) for indirect viewing. Depending upon the type of the vehicle and, in particular, which areas around the vehicle that can be directly seen by the driver, different legal provisions require that certain fields of view can be seen at all times using the device(s) for indirect viewing.

For commercial vehicles, such as e.g. trucks or delivery vehicles, e.g. a primary mirror is currently provided on each of the driver's side and the passenger's side as devices for indirect viewing. Using the primary mirror, the vehicle driver can see a level and horizontal part of the road surface of a certain width, which extends from a stipulated distance behind the vehicle driver's eye point up to the horizon. In addition, a band of lesser width must be visible or viewable for the driver using this mirror, which band begins at a short distance behind the driver's eye point.

In accordance with applicable legal provisions for implementing or providing the required fields of view, commercial vehicles use camera monitor systems in addition to legally-prescribed mirrors for allowing a vehicle driver to monitor the area around the commercial vehicle at all times. Camera monitor systems are often used in road vehicles to present a specific field of view inside the vehicle corresponding to the legally prescribed field of view and captured by one or more cameras, for example. Such camera monitor systems are in particular regulated in the International Standard ISO 16505.

In particular, according to the handbook “ATA's TMC 2014-2015 Recommended Practices Manual” published by the Technology Maintenance Council (TMC) of the American Trucking Association (ATA), a field of view of indirect vision systems is measured according to a cylinder target approach. Therefore, fields of view are typically prescribed by the use of a cylinder placed at specific locations around the vehicle, using the vehicle's geometry as the reference grid to set them up. According to cylinder target approach, the visibility around a vehicle is measured and quantified for dividing the space around the vehicle into different zones.

Besides the above-mentioned International Standard ISO 16505, a further standard called ECE R-46 has been established.

However, in spite of the above-mentioned legally-prescribed mirrors and/or devices for indirect viewing, it is scarcely possible and/or very difficult for a vehicle driver to completely and sufficiently maintain in view at all times the areas around a commercial vehicle that are prone to accidents. Moreover, due to the plurality of mirrors, the burden on the vehicle driver to substantially simultaneously maintain all of these mirrors in view increases. Moreover, because the fields of view are provided using mirrors, the mirrors disrupt the smooth flow of air around the vehicle while driving as a consequence, such that vehicle drag is increased and thus fuel consumption is increased.

In view of the above disadvantages, display devices have been developed for visually depicting the prescribed fields of view of a commercial vehicle. However, for certain commercial vehicles, for example trucks commonly used in North America, it is often difficult to appropriate arrange the display device within a driver's cab of the commercial vehicle, because an inclination of the A-pillar of the driver's cab is substantially less than 90° with respect to the horizontal plane, i.e. an angle of slope of the glass windshield is typically less than 90°, so that it is difficult to arrange the display device such that the driver of the commercial vehicle can easily monitor fields of view displayed on the display device.

Therefore, an object of the invention is to provide a system for visually depicting the prescribed fields of view of a commercial vehicle, with which the fields of view can be monitored in clearly arranged and simple manner, even in commercial vehicles having a glass windshield inclination of less than 90°.

### SUMMARY OF THE INVENTION

The concept underlying the present system is to provide at least one display device disposed within the driver's cab and comprising at least one display unit being configured to display at least one field of view, wherein the at least one display device is configured to be arranged within the driver's cab of the commercial vehicle such that the longitudinal axis thereof is substantially horizontally aligned.

In addition, according to the system of the present invention, at least two different fields of view are displayed on the at least one display device in a common image. According to the present teachings, the field of views are for example displayed on one or more of the display units of the display device in real-time or at least with less than 200 ms delay.

For allowing a driver to easily monitor the display device, the at least one display device is configured to be substantially disposed upright on a driver's side and/or a co-driver's side. For further ensuring that the driver or co-driver can easily at any time monitor the display device, the at least one display device is further configured to be pivotally disposed with respect to the horizontal plane. This allows an easily and quick adaption of the display device to the inclination angle of the A-pillar of the driver's cab or to the inclination of the glass windshield.

The display device used in the system according to the present teaching can be utilized for all of the prescribed fields of view of a commercial vehicle or for only a selected portion thereof. The expression “prescribed field of view” as used according to the present teaching includes a legally-prescribed field of view as well as any other individually defined field of view. In particular, it is possible, e.g., to replace the passenger-side primary and wide-angle mirrors of the commercial vehicle, which are opposite of the driver's side, with the present display device, whereas other mirrors, e.g. the driver's side primary and wide-angle mirrors can be maintained. In the alternative, some or all of the devices for indirect viewing, which have been embodied as mirrors up to now, can be replaced with the display device, if legal conditions allow such a substitution.

According to one embodiment of the present invention, the display device is further configured to be disposed on a driver's side of a commercial vehicle and to depict a field of view on the at least one display unit corresponding to an area left next to the commercial vehicle in forward driving direction. Similar, the display device is further configured to be disposed on the co-driver's side of the commercial vehicle and to depict a field of view on the at least one display unit corresponding to a right area next to the commercial vehicle in forward driving direction.

The fields of view corresponding to fields of views of a mirror, for example a primary mirror, a wide-angle mirror, a fender mirror, a ramp mirror or other commonly known mirrors used for commercial vehicles for monitoring the environment thereof, can be captured, sensed, recorded or detected by at least one image capture unit configured to capture image data representing at least one field of view. The at least one image capture unit is, for example, configured to be integrally formed with a mirror attached to the commercial vehicle, for example with a primary mirror providing a prescribed field of view. It is also possible to provide the image capture unit separate from the mirror.

According to an embodiment of the present invention, a display device is configured to display fields of view of a ramp mirror, a roof mirror, a wide-angle mirror and/or fender mirror, for example, on one or more display units directly bordering each other, separate from each other and/or overlapping each other.

According to an embodiment, at least one field of view contains a field view of a left primary mirror and/or the field of view of a left wide-angle mirror and the field of view of a right primary mirror and/or the field of view of a right wide-angle mirror. In particular, according to the present invention, the display device is adapted to depict the field of view of a left primary mirror and/or the field of view of the left wide-angle mirror on a left side of the at least one display unit.

More preferably, the visual depiction on the display unit(s) of the display device contains the fields of view of a left primary mirror and/or a left wide-angle mirror as well as the fields of view of a right primary mirror and/or a right wide-angle mirror. It is thus particularly preferred to visually depict on the display unit the field of view of the left primary mirror and/or the left wide-angle mirror on the left side and to visually depict on the display unit the field of view of the right primary mirror and/or the right wide-angle mirror on the right side. For the driver, this simplifies the orientation on the display unit, because it corresponds to the orientation of the conditions around the vehicle when the driver is looking in the forward vehicle direction. The orientation in the up-down (vertical) direction of the fields of view of a primary mirror or a wide-angle mirror is preferably arranged such that, with reference to the driver, farther forward-lying areas are portrayed farther above in the image and, with respect to the driver, farther rearward-lying areas are portrayed farther below in the image.

As used in this specification, the directions “forward”, “rearward”, “left” and “right” are each based upon the forward driving direction of the commercial vehicle.

According to a further embodiment of the invention, the display device is adapted to permanently depict the fields of view on the at least one display unit at the same position and with the same size. If the fields of view are permanently depicted on the display unit at the same position and with the same size, it is easier for the driver to readily comprehend which areas he/she is viewing on the display unit. This means, that, independent of the driving situation or other exterior influences, the fields of view are always depicted at the same position in the screen and with the same size.

In the alternative, it is possible to visually depict the fields of view on the display unit in a varying manner, e.g. with respect to their size or position, depending upon, e.g. the driving situation or state. For example, the fields of view may be displayed in accordance with vehicle parameters including at least one or more of steering angle, steering wheel movement, braking amount, vehicle speed, direction indicator and/or turn signal. For example, if a steering angle, steering wheel movement or direction indicator represents a driving situation corresponding to a right turn, only one or more fields of view on the co-driver side may be displayed. Other vehicle parameters based on which the fields of view are displayed, different from the above mentioned may be used. However, it must be ensured that the prescribed fields of view are depicted and are visible (viewable) at all times. For example, it is possible to adapt or modify the visual depiction of the fields of view depending upon the driving speed, so that the visual depiction of the information from the front area of the vehicle is enlarged and the visual depiction of information from the tail area is smaller when slowly driving; on the other hand, the visual depiction of the front area is scaled down and the visual depiction toward the rear is enlarged when driving faster. Finally, when driving in reverse, the focus can lie on the depiction of the information around the passenger side.

In a preferred embodiment, the display device may be further adapted to visually depict additional viewing areas on the display unit, i.e. in addition to the prescribed fields of view. In such an embodiment, a dynamic, i.e. varying depiction of the contents on the display unit is particularly preferred. Such additional viewing areas may include areas that lie outside the prescribed fields of view. Such additional viewing areas can contain, e.g. information from the front area of the commercial vehicle that is outside the prescribed fields of view and/or information from the tail area of the commercial vehicle, which is captured, e.g. by one or more additional reverse driving (rear view) image capture units. In such an embodiment, it is particularly useful when the image contents are dynamically depicted to show a forwardly-expanded view on the display unit when driving slowly. That is, when driving slowly, for example, an additional viewing area that shows information from the front area of the commercial vehicle may be depicted. However, information up to the horizon in the tail area may be omitted. On the other hand, when driving faster, supplemental information from viewing areas in the tail area could be simultaneously depicted in addition to the prescribed fields of view. For example, information captured by one or more rear view cameras and/or image capture units in the tail area may be displayed together with information from fields of view of the primary mirror and the wide-angle mirror.

The information is thus preferably depicted on the display unit such that the information from the viewing areas in the area behind the vehicle is at least partially overlapping and/or blended with fields of view from the primary mirror and the wide-angle mirror. In this case, when driving forward fast, e.g. during a passing manoeuvre, a vehicle, which is not located in the prescribed field of view, but is located in the additionally depicted viewing area(s), is recognizable in the image display of the side vehicle surroundings. This additional visual information further increases driving safety.

According to an embodiment of the present invention, a display device may be designed such that it has a single display unit, independent of the number of depicted fields of view. For example, the visual information normally provided by all of the replaced (omitted) mirrors, e.g. the primary mirror and the wide-angle mirror of both the driver's side and the passenger's side, as well as the front mirror and the close-proximity mirror, could be displayed using a single display unit, e.g. a screen, which is disposed, e.g. on a dashboard in the driver's cab. As mentioned above, such a screen is preferably horizontally aligned, i.e. the longitudinal axis of such a screen is substantially horizontally aligned and substantially disposed upright, so that a driver or a co-driver can easily monitor the screen.

In the alternative, it is possible to provide a plurality of display units, which are separated from one another and which could be disposed, as required, at different positions on the display device. For example, if the primary mirror and/or the wide-angle mirror of both vehicle sides are replaced, then separate display units could be provided for the field of view of the left primary mirror and/or the field of view of the left wide-angle mirror and for the field of view of the right wide-angle mirror and/or the field of view of the right primary angle mirror, respectively. In the alternative, such separated display units could be disposed at a central location in the driver's cab. In this case, it is preferred to arrange the display device so as to correspond to the depicted positions of the vehicle surroundings, e.g. to depict left side areas of the vehicle on the left side display unit and to depict right side areas of the vehicle on the right side display unit.

For capturing the information of the to-be-depicted fields of view, at least one image capture unit, preferably a plurality of image capture units, is provided such as e.g. cameras, image sensors and/or other image capturing means. The number of image capture units is at least equal preferably greater than the number of display units. Such an embodiment offers the advantage, e.g. of enabling information for each to-be captured field of view to be redundantly captured by at least two image capture units. Therefore, if one of the image capture units breaks down, the permanent display of the prescribed field of view remains ensured. In addition, to provide a plurality of image capture units for certain to-be-depicted areas, the required dynamics in the display of the fields of view can be ensured more easily.

Preferably, the resolution of the image capture units is higher than the resolution of the at least one display unit. The higher the resolution of the image capture unit is, the better is the possibility to optimize the display of the to-be-depicted information, i.e. the fields of view, because more inputted information is available than to-be-outputted information. Preferably, when a plurality of image capture units is utilized, different resolutions are utilized in the respective image capture units, according to necessity and distance to the to-be-captured area, for example. Thus, it is further preferred that the resolution of the image capture unit for the field of view of the primary mirror is for example higher that the resolution of the image capture units of other fields of view.

Preferably, the display units include a power supply that is independent of the on-board power supply. This is particularly important in order to make the display of the fields of view available also in vehicle situations, in which the vehicle is stationary and is turned-off, i.e. the ignition is off. It is particularly important that a vehicle driver can view, at least when necessary, information within the prescribed fields of view and, if necessary, additional viewing areas when the vehicle is stationary and the ignition is off. This embodiment increases safety and reduces the likelihood of accidents.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention will be described in purely exemplary manner with the assistance of the figures. Same reference numbers generally indicate identical or at least corresponding components throughout the figures.

FIG. 1 shows a schematic illustration of a system according to the present teachings.

FIG. 2 is another schematic illustration of a system according to the present teachings.

FIG. 3 is a schematic illustration of the display device of the system of FIGS. 1 and 2 in more detail.

FIG. 4 shows another schematic illustration of the display device of the system of FIGS. 1 and 2 in more detail.

FIGS. 5a and 5b show plan views of a commercial vehicle for illustrating corresponding fields of view.

FIGS. 6 to 9 show several possibilities for arranging the system according to the present teachings within a driver's cab of a commercial vehicle.

FIGS. 10 to 14 show several possible fields of view displayed by the system according to the present teachings.

### DETAILED DESCRIPTION OF THE PRESENTLY PREFERRED EMBODIMENTS

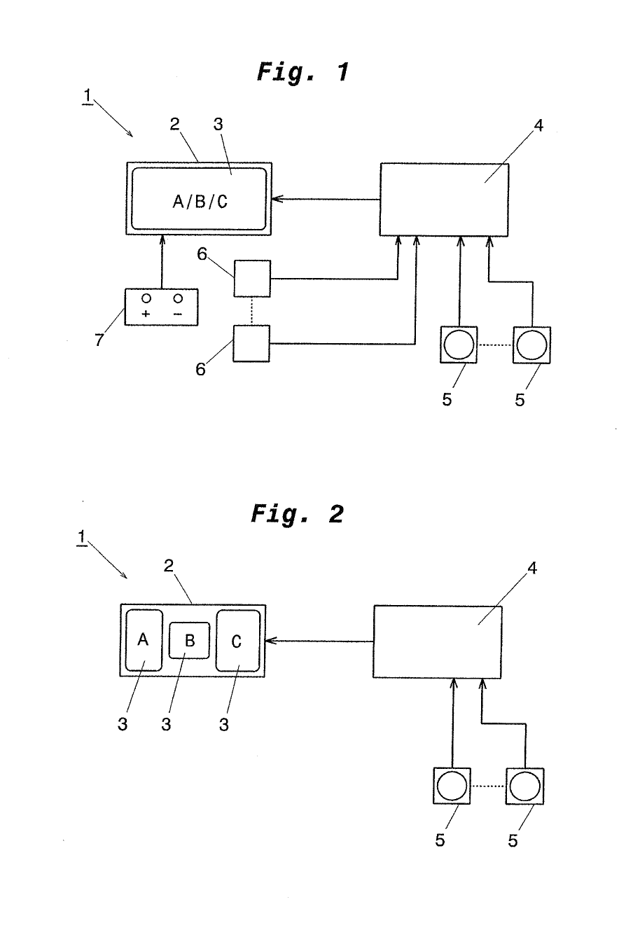

FIGS. 1 and 2 each schematically show a system 1 for visually depicting prescribed fields of view of a commercial vehicle. As shown in FIG. 1, the system comprises a display device 2 including a single display unit 3, whereas according to FIG. 2, a plurality of display units 3 is provided. This/these display unit(s) 3 is/are disposed in the driver's cab of the commercial vehicle, as described in more detail below with reference to FIGS. 6 to 9.

Further, the system 1 according to the present teaching and shown in FIGS. 1 and 2 includes e.g. at least one CPU 4 or other computing unit(s) for processing the information captured by one or more image capture units 5 and for supplying this processed information to the display unit(s) 2 in the form of the prescribed fields of view according to the selected depiction, for example bird's eye view or perspective. The image capture units 5 as shown in FIGS. 1 and 2 can be provided in an arbitrary number as required, i.e. in accordance with the number and the nature of the fields of view to be depicted on the display unit(s) 2.

In addition, according to a further development of the present invention, the system 1 according to FIG. 1 includes connections to various sensors 6, e.g. one or more sensors for detecting the vehicle speed and/or the vehicle state, etc., in order to be able to dynamically, i.e. dependent upon the vehicle state and/or the vehicle speed, depict image contents and information on the display unit 3. For this purpose, the sensors 6 are also connected with the CPU(s) 4, which derive(s) or calculate(s) the to-be-depicted image from the sensor information and the image information from the image capture units 5.

In the embodiment illustrated in FIG. 2, no sensors 6 are provided. Thus, the depiction of the image contents on the display unit 3 is independent of the vehicle speed and the vehicle state according to the system 1 shown in FIG. 2.

Information that is sensed by the image capture unit(s) 5 is supplied to the CPU(s) 4, as well as information from the sensor(s) 6, if provided. The CPU(s) 4 process(es) this information so that, by suitably outputting the processed information to the one or more display units 3, the prescribed fields of view of a commercial vehicle can be depicted on the display unit(s) 3. Two of the prescribed fields of view can be shown in a common image on at least one of the display units 3.

FIG. 1 also shows a power supply device 7 that supplies power to the display device 2, and in particular the display unit 3, independently of an on-board power supply supplying power to various vehicle systems, such as lights, dashboard displays, radio, etc. when the engine is running or when the ignition key has been turned to a power-on position.

The power supply device 7 preferably outputs a regulated current and voltage suitable for driving at least the display unit 3, although it preferably also drives the CPU 4, image capture unit(s) 5 and sensor(s) 6, if provided, so that the entire system can operate, even if the vehicle ignition switch is turned off.

The power supply device 7 can be adapted to obtain power directly from the vehicle battery and/or the vehicle alternator/generator system. In the alternative, the power supply device 7 may contain a separate rechargeable battery that may be connectable to an external energy source or to solar cells or even to an alternator/generator configured to recover energy from deceleration of the vehicle (e.g. an electronic brake).

The display device 1 of FIG. 2 optionally also may receive power from an independent power supply device in the manner similar to the embodiment of FIG. 1.

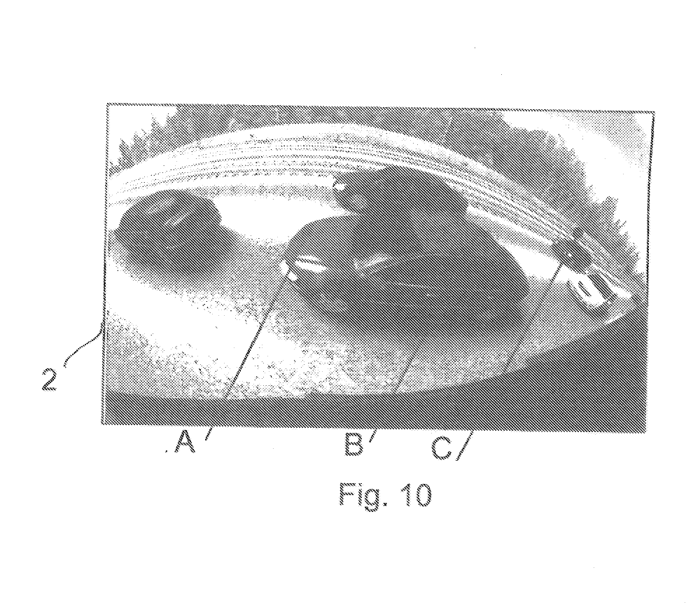

Further, referring to FIGS. 1 and 2, the display units 3 respectively depict fields of view A, B and C. As shown in FIG. 1, the display device 2 which includes a single display unit 3 depicts different fields of view A, B, C in a common image. Such common image could for example be an image in which the fields of view A, B, C are partly overlapped, so that a driver of the vehicle has the impression of a single image, as for example shown in FIG. 10. In particular, the field of view A for example corresponds to a fender mirror, the field of view B corresponds to a ramp mirror and the field of view C corresponds to a wide-angle mirror, for example.

Such fields of view A, B, C as displayed on the display unit 3 are for example captured by one or more image capture units 5 as shown in FIGS. 1 and 2.

Further, referring to FIG. 2, the display unit 2 comprises three separate display units 3, each displaying a corresponding one of the fields of view A, B, C. In particular, the left display unit as shown in FIG. 2 displays a field of view A, which for example corresponds to a fender mirror, wherein the field of view B corresponds to a ramp mirror and wherein the field of view C corresponds to a wide-angle mirror, for example. As shown in FIG. 2, the corresponding display units 3 are separately arranged on the display device such that there is a gap between the display units. However, according to an alternative, the display units 3 as shown in FIG. 2 could be separate components which directly abut against each other without (or substantially without) a gap there between.

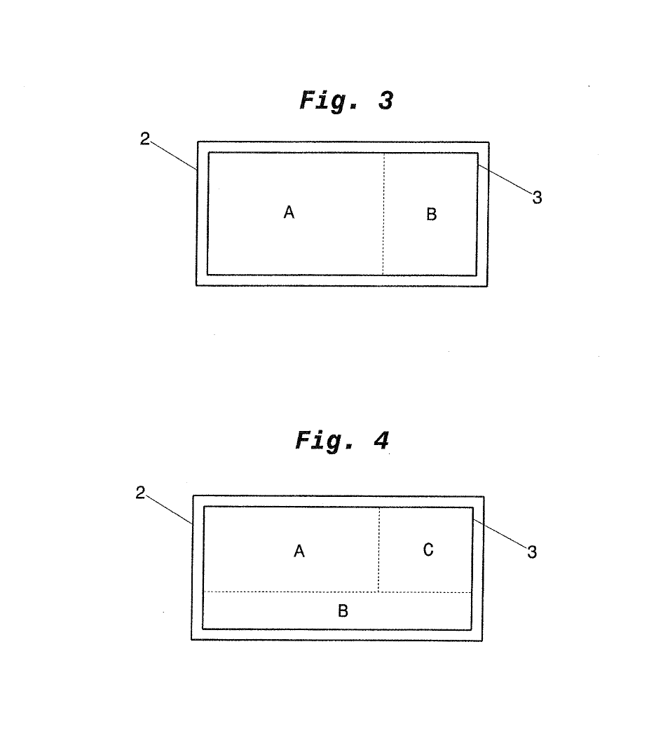

FIGS. 3 and 4 respectively show schematic illustrations of the display devices 2 according to FIGS. 1 and 2. As shown in FIG. 3, fields of view A and B are displayed on the display unit 3 next to each other, for example. As shown in FIG. 4, three fields of view A, B, C are displayed on the display unit 3 such that the field of view A is next to the field of view C in longitudinal direction of the display device 2, whereas the field of view B is located under the fields of view A, C, for example.

According to the present teaching, the display device is aligned such that the longitudinal axis thereof is substantially horizontal as explained in more detail with reference to FIGS. 6 to 9.

Although only three fields of view A, B, C are mentioned above, of course less or more may be displayed.

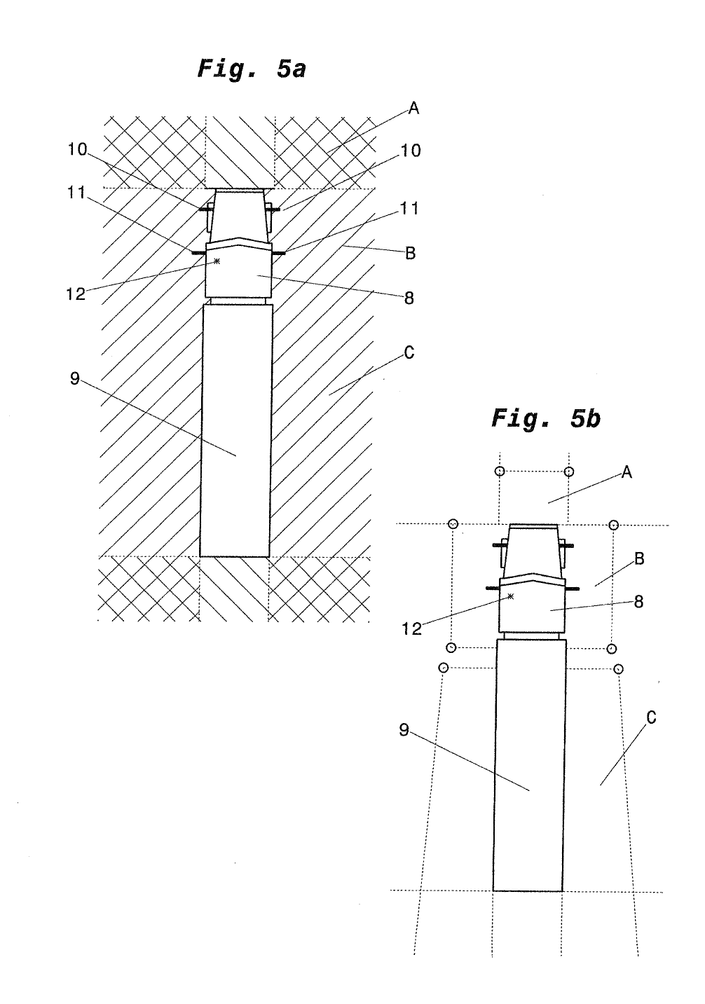

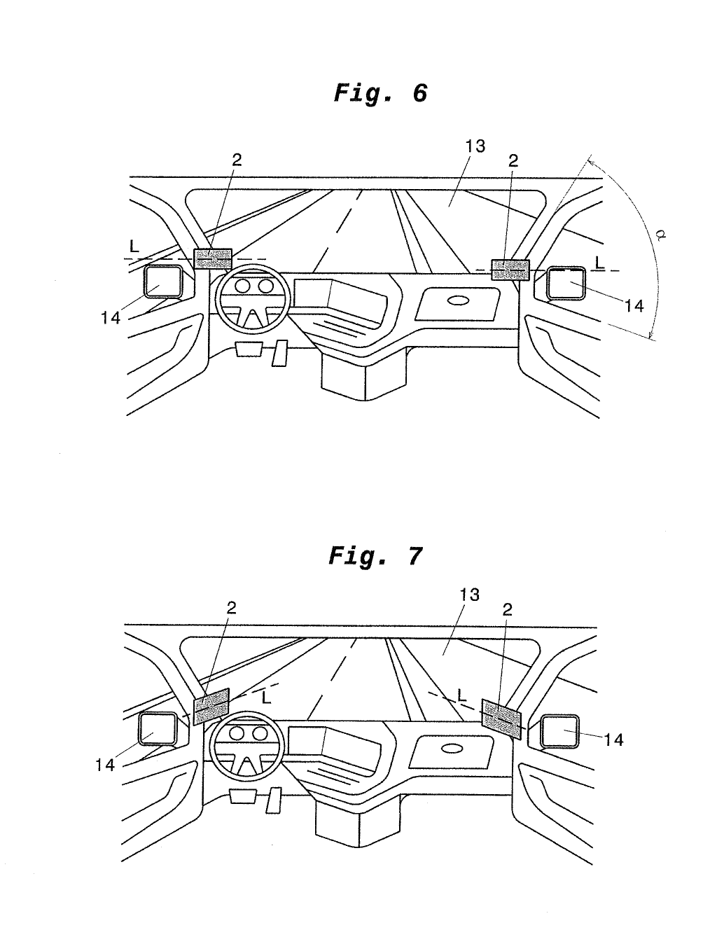

FIGS. 5a and 5b schematically illustrate a top view (view from above) of a commercial vehicle comprising a driver's cab 8 and a trailer 9. As shown in FIGS. 5a and 5b, fender mirrors 10 and ramp mirrors 11 are provided on a left side and a right side of the driver's cab, respectively. The ramp mirrors 11 shown in FIGS. 5a and 5b correspond to the primary mirrors shown in FIGS. 6 to 9, for example.

According to the present teachings, each of these mirrors may be integrally formed together with the above-mentioned image capture unit 5 as shown in FIGS. 1 and 2. The image capture units provided in the fender mirrors 10 are configured to capture image data representing a field of view A, for example, which is laterally in front of the driver's cab 8, for example. Further, the image capture unit provided in the ramp mirror 11 is configured to capture image data representing for example a field of view B which is (left/right) next to the driver's cab 8. Alternatively, as shown in FIG. 5b, the image capture unit provided in the ramp mirror 11 could be configured to capture image data corresponding to a field of view A directly in front of the driver's cab 8, for example. The differently shaded areas shown in FIG. 5a each correspond to a respective field of view which corresponds to image data captured by a corresponding image capture unit, wherein the corresponding fields of view are respectively displayed on the display device (display unit) as shown in FIGS. 1 and 2.

As mentioned above, according to the present teachings, the system 1 shown in FIGS. 1 and 2 is provided within the driver's cab 8 such that the corresponding fields of view can be displayed to the driver 12 of the driver's cab 8.

In particular, referring to FIGS. 6 to 9, different possible positions within the driver's cab 8 are illustrated for arranging the display device 2 of FIGS. 1 and 2.

Referring to FIG. 6, the display device 2 according to the present teaching is arranged within the driver's cab of the commercial vehicle such that the longitudinal axis L thereof is substantially horizontally aligned. As shown in FIG. 6, a display device 2 is provided on the driver's side and on the co-driver's side, for example. Of course, only one display device 2 may be provided either on the driver's side or on the co-driver's side.

As shown in FIG. 6, the longitudinal axis L of the display device 2 is horizontally aligned, so that an inclination a of the A-pillar of the vehicle is appropriately considered in the case that the inclination is less than 90°, for example 75°. Such an alignment facilitates mounting of the display device.

FIG. 7 shows the arrangement of a display device 2 on a driver's side and co-driver's side, wherein similar to FIG. 6, the longitudinal axis L of display device 2 is substantially horizontally aligned. However, in contrast to FIG. 6, the display devices 2 are a slightly inclined to the driving direction for facilitating monitoring fields of view displayed thereon. The display device 2 of the present teachings is for example pivotable around an axis perpendicular to the horizontal plane for achieving such an appropriate inclination to the driving direction. For improving mountability the display device 2 according to the present teachings is for example also pivotable around its longitudinal axis L. In this way, it is possible to correspondingly adapt the arrangement of the display device near the A-pillar of the vehicle by considering the inclination angle thereof.

Further, as shown in FIGS. 6 and 7, two primary mirrors 14 are provided respectively on the driver's side and the co-driver's side. These primary mirrors 14 provide a depicted field of view. The primary mirrors 14 having a size of at least 50 inch² and being covered with flat glass. As shown in FIGS. 6 to 9, the display devices 2 are in addition provided to the primary mirrors 14 for improving driving safety.

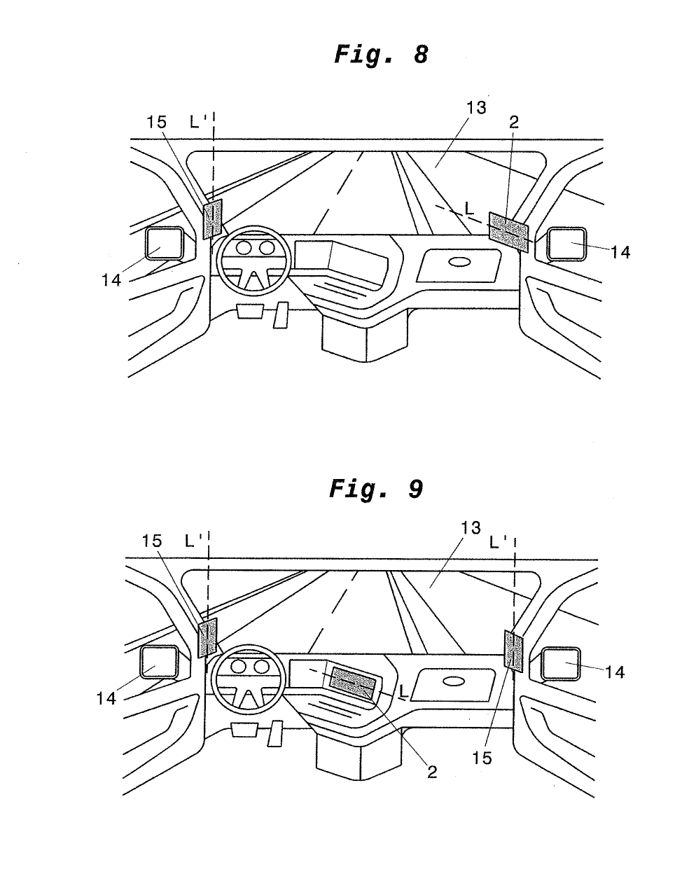

As shown in FIG. 8, a display device 2 according to the present teachings is only provided on the co-driver's side and arranged such that the longitudinal axis L thereof is substantially horizontally aligned and slightly inclined in driving direction, similar to FIG. 7. In addition, FIG. 8 shows a monitor device 15 provided on the driver's side, wherein a longitudinal axis L′ thereof is arranged perpendicular to the horizontal plane, i.e. in contrast to the display device 2. Therefore, in cases that an angle of inclination of the glass windshield 13 (A-pillar) is less than 90°, the size of the display of the monitor device 15 must be smaller than the display device 2, due to its above mentioned orientation. Thus, according to the monitor device 15, the above mentioned advantages of the display device 2 are not achieved and the objection of the present invention cannot be solved.

Referring to FIG. 9, two monitor devices 15 are provided on each side of a driver's side and a co-driver's side, both having a small size compared to the display device 2, as explained above. Similar to FIG. 8, longitudinal axes L′ thereof are substantially orthogonal to the horizontal plane. In addition, as shown in FIG. 9, the display device 2 according to the present teaching is provided between the driver side and the co-driver side integrally mounted in the dashboard, for example, such that the longitudinal axis L thereof is substantially horizontally aligned.

FIGS. 10 to 14 show different possibilities for depicting fields of view on the display device according to the present teaching.

Referring to FIG. 10, the display device 2 shows three fields of view A, B, C, wherein the field of view A corresponds to the field of view of a fender mirror, the field of view B corresponds to the field of view of a ramp mirror and the field of view C corresponds to the field of view of a wide-angle mirror. According to FIG. 10, the fields of view are displayed as a single image in landscape mode. The three fields of view A, B, C are for example captured with a single image capture unit. In the case of FIG. 10, the side areas of the co-driver's side are in particular displayed.

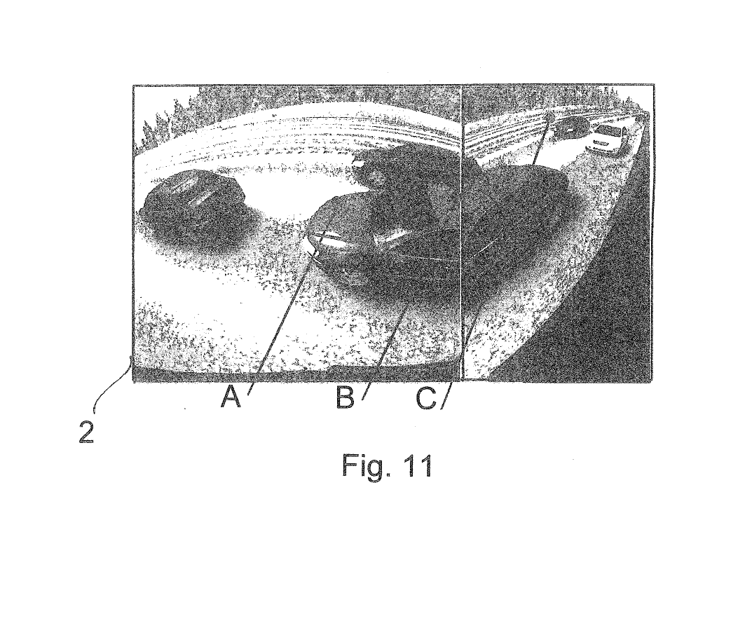

Referring to FIG. 11, the display device 2 shows three fields of view A, B, C, wherein the fields of view A, B, are captured by an image capture unit and the field of view C is captured by a separate image capture unit, for example. Similar to FIG. 10, the field of view A corresponds to a field of view of fender mirror, the field of view B corresponds to a field of view of a ramp mirror and the field of view C corresponds to a field of view of a wide-angle mirror, for example. According to FIG. 11, no “blind area” of the co-driver's side is displayed because the fields of view A/B and C partly overlap.

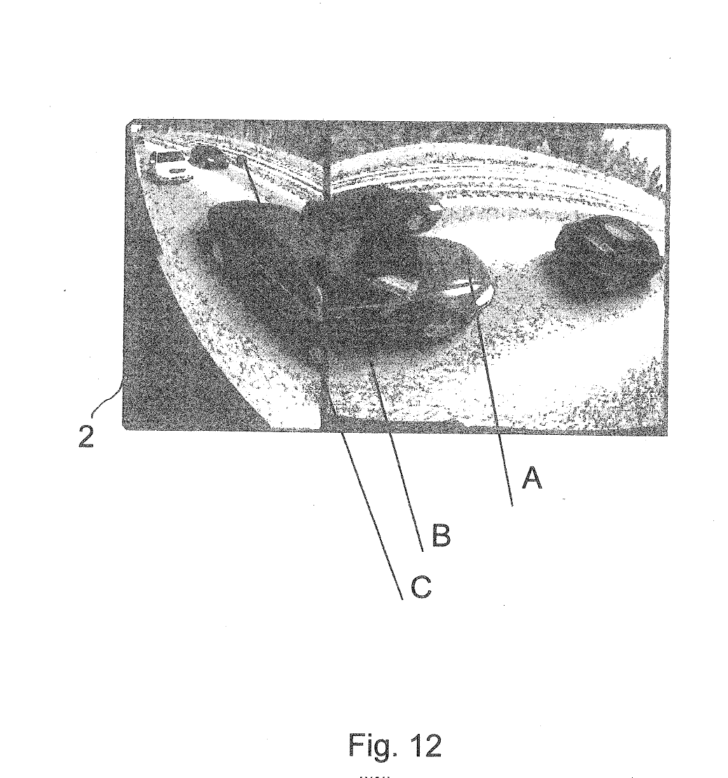

FIG. 12 shows a display device 2 provided on the driver's side. As shown in FIG. 12, the field of view A corresponds to the field of view of a fender mirror, the field of view B corresponds to the field of view of a ramp mirror and the field of view C corresponds to the field of view of a wide-angle mirror. Similar to FIG. 11, no “blind area” of the driver's side is displayed because the fields of view A/B and C partly overlap.

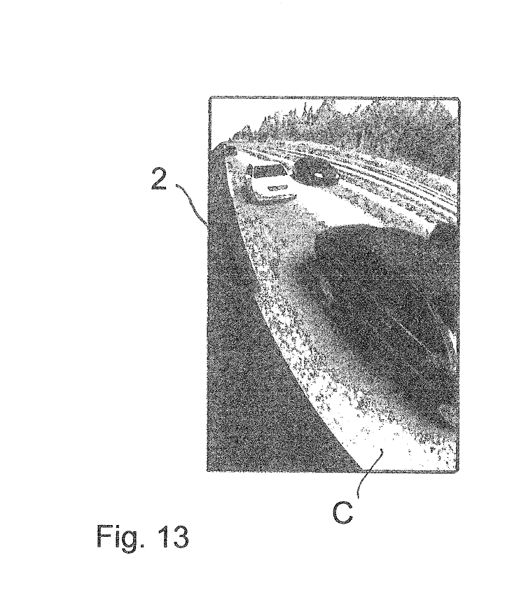

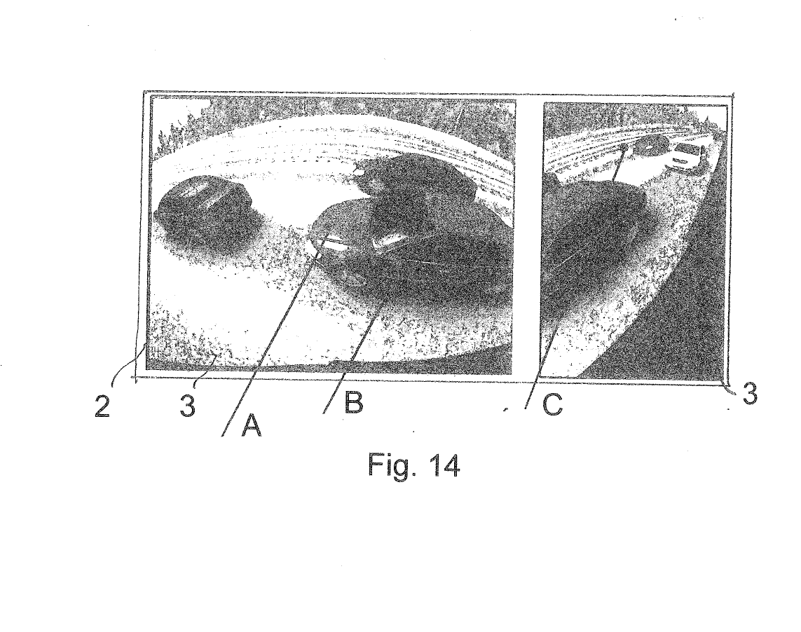

As shown in FIG. 13, it is also possible according to the system of the present teaching to display less than two fields of view on the display device 2 in particular, the display device 2 of FIG. 13 only displays one field of view C corresponding to the wide-angle mirror, for example.

FIG. 14 shows a display device 2 substantially corresponding to FIG. 11, wherein the display device 2 comprises two display units 3. The display unit 3 on the left side of the display device 2 displays an image corresponding to fields of view A, B, whereas the display unit 3 on the right side of the display device 2 displays an image corresponding to the field of view C corresponding to a wide-angle mirror. The display unit 3 on the left side is separated from the display unit 3 on the right side of the display device 2, so that the corresponding images do not overlap.

As mentioned above, more than two display units could be provided in the display device 2.

Representative, non-limiting examples of the present invention were described in detail above with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved display.

Moreover, the combinations of features disclosed in the above detailed description may not be necessary to practice the invention in the broadest sense, and are instead taught merely to particularly describe representative examples of the invention. Furthermore, various features of the above-described representative examples, as well as the various independent and dependent claims, may be combined in ways that are not specifically and explicitly enumerated in order to provide additional useful embodiments of the present teachings.

All features disclosed in the description and/or the claims are intended to be discloses separately and independently from each other for the purpose of original written disclosure, as well as for the purpose of restricting the claimed subject-matter, independent of the compositions of the features in the embodiments and/or the claims. In addition, all value ranges or indication of groups of entities are intended to disclose every possible intermediate value or intermediate entity for the purpose of original written disclosure, as well as for the purpose of restricting the claimed subject-matter.

All above mentioned image capture units are for example digital CCD-cameras, wherein the resolution of the CCD sensor thereof is for example 1,3 Mexapixel or higher. Further, a viewing angle of a field of view corresponding a wide-angle mirror is for example more than 50 degree and less than 60 degree, whereas a viewing angle of a field of view corresponding to a ramp mirror, primary mirror and/or fender mirror is more than 90 degree, for example. Other values for resolution and viewing angle may be used without leaving the scope of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for visually depicting fields of view for a commercial vehicle within a driver's cab of the commercial vehicle, the system comprising:
at least one display device disposed within the driver's cab and comprising at least one display unit being configured to display at least one field of view (A, B, C), wherein
the at least one display device is configured to be arranged within the driver's cab (8) of the commercial vehicle such that the longitudinal axis thereof is substantially horizontally aligned.

2. The system according to claim 1, wherein the at least one display device is configured to be substantially disposed upright on a driver's side and/or a co-driver's side.

3. The system according to claim 1, wherein the at least one display device is configured to be substantially disposed upright on a driver's side and/or a co-driver's side and to be pivotally disposed with respect to the horizontal plane.

4. The system according to claim 1, wherein the at least on display device is configured to be disposed on a driver's side of the commercial vehicle and to depict a field of view on the at least one display unit, the field of view corresponding to an area left next to the commercial vehicle in forward driving direction.

5. The system according to claim 1, further comprising:
at least one image capture unit configured to capture image data representing the at least one field of view, wherein the at least one image capture unit is configured to be integrally formed with a mirror attached to the commercial vehicle, the mirror providing a prescribed field of view.

6. The system according to claim 1, wherein the system is configured to display fields of view of a roof mirror, a wide-angle mirror and/or fender mirror on one or more display units directly bordering each other, separate from each other and/or overlapping each other on the at least one display device.

7. The system according to claim 6, wherein the system is configured to display the fields of view in accordance with vehicle parameters.

8. The system according to claim 1, wherein the system is configured to display adjacent fields of view (A, B, C) directly bordering each other on the at least one display device.

9. The system according to claim 1, wherein the at least one field of view (A, B, C) contains the field of view of a left primary mirror and/or the field of view of a left wide-angle mirror and the field of view of a right primary mirror and/or the field of view of a right wide-angle mirror.

10. The system according to claim 9, wherein the system is adapted to depict the field of view of the left primary mirror and/or the field of view of the left wide-angle mirror on the left side of the at least one display unit.

11. The system according to claim 9, wherein the system is adapted to depict the field of view of the right primary mirror and/or the field of view of the right wide-angle mirror on the right side on the display unit.

12. The system according to claim 10, wherein the system is adapted to depict the field of view of the right primary mirror and/or the field of view of the right wide-angle mirror on the right side on the display unit.

13. The system according to claim 1, wherein the system is adapted to permanently depict the fields of view (A, B, C) on the at least one display unit at the same position and with the same size.

14. The system according to claim 1, wherein the system is adapted to permanently depict the fields of view (A, B, C) on the at least one display unit at varying positions and/or with varying sizes.

15. The system according to claim 1, wherein the system is adapted to depict at least one additional viewing area in accordance with the vehicle speed and/or vehicle driving direction.

16. The system according to claim 14, wherein the system is adapted to display, with reference to the commercial vehicle, position information superimposed with at least one of the fields of view (A, B, C) or the at least one of the viewing areas.

17. The system according to claim 1, wherein the display device includes two, three or four display units, which are separated from each other.

18. The system according to claim 1, wherein the display device includes at least two image capture units and the system is adapted to combine the field of view information for one to-be-depicted field of view from the field of view information of the at least two image capture units.

19. The system according to claim 1, wherein the display device includes at least two image capture units, which are adapted to sense redundant field of view information for one to-be-depicted field of view (A, B, C).

20. The system according to claim 1, wherein a first image capture unit having a first resolution for capturing a first angle of view and a second image capture unit having a second resolution for capturing a second angle of view, which is different from the first angle of view, are provided, and wherein the first resolution is higher than the second resolution, and wherein the two viewing areas captured by the image capture units are shown in a common display unit and do not substantially overlap, wherein the confluence portion of the field of view of a primary mirror and the field of view of a wide-angle mirror of the same vehicle side is shown, where-in preferably the first angle of view is smaller than the second image angle of view.

21. The system according to claim 1, further including a power supply device that is independent of an on-board power supply of the commercial vehicle.

22. A system for visually depicting fields of view for a commercial vehicle within a driver's cab of the commercial vehicle, the system comprising:
at least one display device disposed within the driver's cab and comprising at least one display unit being configured to display at least two different fields of view (A, B, C), wherein the at least two different fields of view are displayed on the at least one display device in a common image, and
the at least one display device is configured to be arranged within the driver's cab of the commercial vehicle such that the longitudinal axis thereof is substantially horizontally aligned.

23. The system according to claim 22, wherein the at least one display device is configured to be substantially disposed upright on a driver's side and/or a co-driver's side.

24. The system according to claim 22, wherein the at least one display device is configured to be substantially disposed upright on a driver's side and/or a co-driver's side and to be pivot-ally disposed with respect to a horizontal plane.

25. The system according to claim 22, further comprising at least one image capture unit configured to capture image data representing the at least one field of view, wherein the at least one image capture unit is configured to be integrally formed with a mirror attached to the commercial vehicle, the mirror providing a prescribed field of view.

26. The system according to claim 22, wherein the system is configured to depict the different fields of view (A, B, C) on one or more display units overlapping each other.

27. The system according to claim 22, wherein the system is configured to be disposed on the co-driver's side within the driver's cab, wherein the at least two fields of view correspond to areas right next to the commercial vehicle in forward drive direction.

28. The system according to claim 22, wherein the system is configured to display fields of view of a roof mirror, ramp mirror, a wide-angle mirror and/or fender mirror on one or more dis-play units directly bordering each other, separate from each other and/or overlapping each other.

29. The system according to claim 28, wherein the system is configured to display the fields of view in accordance with vehicle parameters.

30. The system according to claim 22, wherein the system is configured to display adjacent fields of view directly bordering each other.

31. The system according to claim 22, wherein the at least one field of view contains the field of view of a left primary mirror and/or the field of view of a left wide-angle mirror and the field of view of a right primary mirror and/or the field of view of a right wide-angle mirror.

32. The system according to claim 31, wherein the system is adapted to depict the field of view of the left primary mirror and/or the field of view of the left wide-angle mirror on the left side of the at least one display unit.

33. The system according to claim 31, wherein the system is adapted to depict the field of view of the right primary mirror and/or the field of view of the right wide-angle mirror on the right side on the display unit.

34. The system according to claim 22, wherein the system is adapted to permanently depict the fields of view on the at least one display unit at the same position and with the same size.

35. The system according to claim 22, wherein the system is adapted to permanently depict the fields of view on the display unit at varying positions and/or with varying sizes.

36. The system according to claim 22, wherein the system is adapted to depict at least one additional viewing area in accordance with the vehicle speed and/or vehicle driving direction.

37. The system according to claim 36, wherein the system is adapted to display, with reference to the commercial vehicle, position information superimposed with at least one of the fields of view (A, B, C) or the at least one of the additional viewing areas.

38. The system according to claim 22, wherein the display device includes two, three or four display units, which are separated from each other.

39. The system according to claim 22, wherein the display device includes at least two image capture units and the display device is adapted to combine the field of view information for one to-be-depicted field of view from the field of view information of the at least two image capture units.

40. The system according to claim 22, wherein the display device includes at least two image capture units, which are adapted to sense redundant field of view information for one to-be-depicted field of view.

41. The system according to claim 22, wherein a first image capture unit having a first resolution for capturing a first angle of view and a second image capture unit having a second resolution for capturing a second angle of view, which is different from the first angle of view, are provided, and wherein the first resolution is higher than the second resolution, and wherein the two viewing areas captured by the image capture units are shown in a common display unit and do not substantially overlap, wherein the confluence portion of the field of view of a primary mirror and the field of view of a wide-angle mirror of the same vehicle side is shown, where-in preferably the first angle of view is smaller than the second image angle of view.

42. The system according to claim 22, further including a power supply device that is independent of an on-board power supply of the commercial vehicle.
